(19) United States
(12) Patent Application Publication
(10) Pub. No.: US 2014/0300205 A1
(43) Pub. Date: Oct. 9, 2014

(54) CONTACTLESS POWER SUPPLY AND SIGNAL TRANSMISSION THROUGH A CLADDING ELEMENT FOR BUILDING PARTS

(71) Applicant: Grossenbacher System AG, St. Gallen (CH)

(72) Inventor: Andreas Schimanski, Sigolsheim (FR)

(73) Assignee: GROSSENBACHER SYSTEM AG, St. Gallen (CH)

(21) Appl. No.: 14/356,732

(22) PCT Filed: Nov. 14, 2012
(86) PCT No.: PCT/EP2012/004729

§ 371 Date: May 7, 2014

(30) Foreign Application Priority Data
Nov. 15, 2011 (DE) 102011118564.3

(51) Int. Cl. H02J 5/00

(52) U.S. Cl. CPC H02J 5/005
USPC 307/104

(57) ABSTRACT

A planar cladding element(4) for surfaces of planar building parts, in particular in operating rooms, rooms prone to moisture or on building surfaces that are accessible for moisture, which cladding element is equipped with a transmission device (1) for electrical energy and/or electrical signals, which transmission device includes a supply module (5) for electrical energy and/or electrical signals and a discharge module (6) for electrical current and/or electrical signals, which modules can be releasably connected to each other in such a way that the electrical energy and/or the electrical signals can be transmitted, characterized in that in the transmission device (4) specified at the beginning the supply module (5) is arranged behind the cladding element (4) without an interruption, while the discharge module (6) is arranged in front of the cladding element (4) without an interruption, and in that both modules (5, 6) include elements for the inductive transmission of electrical energy and/or electrical signals from the supply module (5) to the discharge module (6) and/or in the case of electric signals in a reverse direction, as well as devices for fastening the discharge module (6) without an interruption and in a releasable manner. The invention also relates to correlating uses and methods.

### BACKGROUND

The application relates to a (possibly at least partially transparent) sheet-like cladding element (covering element) for surfaces of planar building parts, which cladding element is equipped with a transmission apparatus for electrical energy and/or electrical signals (for data transmission), which transmission apparatus comprises (in particular consists of) a supply module for electrical energy and/or electrical signals and a discharge module for current and/or electrical signals, it being possible for said supply module and discharge module to be releasably connected to one another in such a way that the electrical energy and/or the electrical signals can be transmitted, and also to a building interior which is equipped with one or more cladding elements of this kind and/or to a building having at least one outer surface which is equipped with said cladding element. Uses and methods which are explained in greater detail below are also embodiments of the present invention.

A relatively recent technology in operating rooms has been to provide the inside of the walls of said operating rooms with glass walls in order to obtain surfaces which have as few joints as possible and are smooth and are therefore easy to keep clean and allow high hygiene standards to be achieved. This is necessary particularly in view of increasing risks, for example, due to viruses which are resistant to many antibiotics (such as MRSA=Multidrug Resistant Staphylococcus Aureus), in the field of surgery. Operating rooms which are equipped in this way are also called “blue ORs” since a corresponding shade and/or (for example LED) lighting is possible or prevails.

However, it is also necessary to ensure power is supplied to equipment in the operating room itself, such as OR field cameras, C-frames, ultrasound devices, lighting equipment, ultrasound devices, endoscopic switching elements, recording devices for recording an operation, breathing equipment, equipment for anesthesia, monitoring equipment, heart-lung machines, electrically operated surgical equipment, video-conferencing systems and the like, for example. Customary connections, such as plug sockets for transmitting power and suitable connections for signal transmission (including data transmission), such as Ethernet, are used for this purpose. However, these have to be incorporated within the walls in apertures through the glass walls, and therefore new joints and possibly recesses are produced which can store hidden germs and dirt. Claddings for walls using glass are also, besides the hygiene effects, architecturally exciting variants from a design point-of-view or for other reasons in the domestic sector too, these variants allowing, in addition to lighting effects (for example by LEDs), display screens or the like to be accommodated behind the glass. In this case too, it would be desirable to allow power to be supplied to electrical devices and equipment in the room interior by means of current connections, without apertures resulting in an increase in the number of joints (for example which have an adverse effect in respect of hygiene, for example allow dust to collect) in the process.

Furthermore, it is difficult to make current or electrical signals accessible by means of plug receptacles or sockets or the like which are sufficiently protected against moisture, such as splashes, rain or fog, in order to protect against corrosion and short circuits, on outer walls and surfaces. Corresponding difficulties are also encountered in damp interior rooms (rooms which are subject to moisture).

In the case of inductive energy and/or signal transmission, there is firstly also a risk of electrical devices interfering with one another via undesired electrical or electromagnetic effects, and also the risk, due to a lack of electromagnetic environmental compatibility, of, for example, rooms or regions being subject to potentially harmful electromagnetic fields (“electrosmog”). In this case, “electromagnetic compatibility” (EMC) is the normally desired state in which technical devices or equipment do not influence one another by virtue of undesired electrical and/or magnetic effects. A series of provisions, such as Directive 2004/108/EC, OJ EC No. L 390/24, 12.31.2004, or DIN/EN Standards EN 61000-6-1: 2007 (Immunity for residential, commercial and light-industrial environments); EN 610000-6-3:2007 (Emission standard for residential, commercial and light-industrial environments), EN 61000-6-4: 2007 (Emission standard for industrial environments), EN 60601-1-2: 2007 (Medical electrical equipment), EN 55016-2-3:2006 (Emission standard: Disturbance field strength—Radiated disturbance measurement), EN 55022:2006 +A1:2007: Emission standard: Information technology equipment—Limits and methods of measurement) and also EN 55022:2006 (Emission standard: Information technology equipment—Limits and methods of measurement), provide information concerning permissible limits and methods of measurement—these are incorporated herein by way of reference. For electromagnetic environmental compatibility as part of EMC, limits are specified which advantageously should comply with the following, for example electrical field strengths of 5 kV/m and magnetic flux densities of 100 μT in the case of 50-Hz fields, electrical field strengths of 10 kV/m and magnetic flux densities of 300 μT in the case of 16.7-Hz fields (in accordance with the 26th Federal Air Pollution Control Order [BImSchV]). Therefore, the limits for high-frequency emissions can be defined pursuant to CISPR11 group 1 or CISPR11 class B, those for emissions of harmonics can be defined pursuant to IEC 61000-3-2 class A and those for the emission of voltage fluctuations/flicker can be defined pursuant to IEC 61000-3-3 (cf. http://www.emeko.de/uploads/media/17-Med-Norm-60601-1-2ed200X_YY.pdf). As an alternative, the values pursuant to IEC 60601-1-2 (cf. http://www.emeko.de/uploads/media/17-Med-Norm- 60601- 1-2ed200X_YY.pdf) may be important.

### SUMMARY

Against this background, the object is to allow power to be supplied to devices and/or for signals to be transmitted in the case of building surfaces which are clad (for example with glass) on the surface, but in the process to keep the number of joints at as low a level as possible and to overcome the other cited disadvantages and difficulties, in particular to ensure electromagnetic compatibility (in this case, this term also serves as a generic term for electromagnetic environmental compatibility).

This object is achieved within the scope of a first embodiment of the invention in that, in the transmission apparatus which is mentioned in the introductory part, the supply module for electrical energy and/or electrical signals is arranged behind the sheet-like cladding element (on the substrate side) without an interruption (in each case from the point-of-view of an observer standing in front of a wall), while the discharge module is arranged in front of the cladding module on the observer side (on the viewing side) without an interruption, and the two modules contain elements for the inductive transmission of electrical energy and/or electrical signals from the supply module to the discharge module and also contain devices for fastening the discharge module without an interruption and in a releasable manner (in particular level with the supply module), wherein the supply and the discharge module(s) is/are preferably designed in such a way that they, at most, can emit permissible quantities of disturbance radiation or preferably cannot emit any disturbance radiation to the surrounding area, wherein the sheet-like cladding element is provided for or fitted to, in particular, a wall, a ceiling or a floor or two or more thereof in an operating room or a room which is subject to moisture or an outer surface (which is accessible to moisture) of a building.

A second embodiment of the invention relates to the use of a supply module according to the invention for electrical energy and/or electrical signals which is arranged behind (on the substrate side of) said sheet-like cladding element for surfaces of planar building parts in the building interior and/or on a building outer surface without an interruption, and to the use of a discharge module for current and/or electrical signals which is arranged on that side of the cladding element which is opposite the supply module for electrical energy (on the viewing side) without an interruption and in a releasable manner, for the inductive transmission of electrical energy and/or electrical signals from the supply module for electrical energy to the discharge module and/or (primarily in the case of electrical signals) in the opposite direction (from the discharge module to the feed module), wherein the supply and the discharge module(s) is/are preferably designed in such a way that they, at most, can emit permissible quantities of disturbance radiation or preferably cannot emit any disturbance radiation to the surrounding area, wherein the sheet-like cladding element is provided for or fitted to, in particular, a wall, a ceiling or a floor or two or more thereof in an operating room or a room which is subject to moisture or an outer surface (which is accessible to moisture) of a building. The transmitted electrical energy can then be fed from the discharge module, as electric current, to a current consumer and/or can be forwarded as signals for data transmission to a signal-processing and/or signal-emitting apparatus, or conversely electrical signals can be forwarded from an apparatus of this kind, via the discharge module, to the supply module and then forwarded to other signal-processing and/or signal-emitting apparatuses.

A further embodiment of the invention relates to a method for the transmission of electrical energy and/or electrical signals through a sheet-like cladding element for surfaces of planar building parts, in which method current and/or electrical signals is/are converted into a magnetic alternating field in a supply module for electrical energy and/or electrical signals, which supply module is arranged behind (on the substrate side of) said cladding element without an interruption, said magnetic alternating field being at least partially received by a discharge module for electric current and/or electrical signals, which discharge module is arranged on that side of said cladding element which is opposite the supply module (on the viewing side) without an interruption and in a releasable manner, and is converted into a voltage which can create a current in a further method step (closing of an electrical circuit), which current can be fed to a current consumer or is used, and/or into electrical signals which can be forwarded to a signal-processing and/or signal-emitting apparatus or are used, and/or wherein conversely electrical signals (for example from one or more signal-emitting apparatuses) can be converted into a magnetic alternating field by said discharge module and transmitted to the supply module and received and converted into electrical signals there and can be forwarded to signal-processing and/or signal-emitting apparatuses or are used, wherein the supply and the discharge module(s) is/are preferably designed in such a way that they, at most, can emit permissible quantities of disturbance radiation or preferably cannot emit any disturbance radiation to the surrounding area, wherein the sheet-like cladding element is provided for or fitted to, in particular, a wall, a ceiling or a floor or two or more thereof in an operating room or a room which is subject to moisture or an outer surface (which is accessible to moisture) of a building.

In all of the embodiments of the invention, each wall, floor or ceiling is preferably provided with not more than 10, not more than 8, or not more than 6, not more than 5, for example not more than 3, for example 1 or two supply module/discharge module pair(s), in order to keep the disturbance radiation as low as possible.

Specific embodiments of the invention relate to a supply module for electrical energy and/or electrical signals, as defined in the preceding text and that which follows, and/or to a discharge module for current and/or electrical signals, as defined in the preceding text and that which follows.

A further embodiment of the invention relates to a cladding element according to the present invention which is additionally equipped with a recognition system for the presence and/or characterization of an object or of a material (in particular with a touchscreen), and also to corresponding methods and uses as described above and below. A cladding (here, covering) element of this kind is described in DE 10 2011 116 000 which is included by reference here in this respect.

The subjects of the present invention are particularly advantageous for operating rooms (ORs) since they allow smooth walls which are easy to keep clean and do not have recesses as would otherwise always be present for plug receptacles or the like which are incorporated in or mounted on the wall, the floor and/or the ceiling.

The subjects of the present invention are also advantageous in outer walls or in damp interiors since you allow the presence of supply modules which are not sensitive to moisture and are not sensitive to short circuits behind a cladding element according to the invention, while the discharge module can be mounted only in the event of use.

The following definitions serve as possible more specific descriptions of general terms and features which are cited in the embodiments of the invention which are cited in the preceding text and that which follows and in the claimed embodiments of the invention, wherein one, two or more or all of the relatively general terms and features in the respectively described groups of terms and features for specific embodiments of the invention can be replaced by more specific terms, this leading to more specific embodiments of the invention which are particularly preferred in a preferred interpretation of the present disclosure.

A (possibly at least partially transparent) sheet-like cladding element (also can be called covering element or is called a cladding element for short in the preceding text and that which follows) for surfaces of planar building parts is preferably defined as follows: in a preferred embodiment of the invention, the cladding element can be opaque, or it can be at least partially transparent. At least partially transparent means that the cladding element is at least partially permeable to electromagnetic waves, in particular in the range which is visible to the human eye, so that images on the rear face or behind it can be seen, and/or that at least a portion of the surface of the cladding element is transparent. The transparency can also be interrupted by, for example, electrically switchable light transmissivity (which can be activated and can be deactivated) (“intelligent glass”), so that images or energy supply modules which are situated behind it for example are visible only on contact. Therefore, various designed effects can be achieved on said technical basis. In this case, “partially” means that one or more regions of the cladding element may also be (permanently) opaque (not transparent), while other regions, for example those behind which display screens, touchscreens, interesting wall, floor or ceiling substrates or lighting elements, or combinations of two or more thereof can be situated, are at least temporarily transparent. However, the entire cladding element can also be of transparent design.

A corresponding cladding element can be composed of a material which is diamagnetic (for example with a magnetic susceptibility of less than 0 (zero)) and electrically insulating (electrical conductivity of, for example, less than 5×10⁻¹⁰ S•cm⁻¹) and coated (for example coated with a surface-hardening, anti-glare, electrochromic, colored (for example by printing), or other possible material or coating system or, for example, LEDs or OLED material or the like which allows the appearance of the covering element to be varied as desired), or is coated with an opaque, if desired colored (for example blue), coating (for example on the rear face of the cladding element which is directed toward the substrate) or can be composed of an uncoated (preferably at least partially transparent) material, wherein plastic, for example acrylic (“Plexiglas”) or in particular glass (for example soda-lime glass or aluminum-silicate glass), are particularly preferred, or alternatively can be composed of a ceramic (possibly enamel-coated) material.

In this case, the thickness can be in the range of from 0.1 to 100 mm, preferably in a range which allows the electrical energy to be transmitted with as low a level of loss as possible in accordance with the induction principle, for example in the range of from 0.1 to 20 mm, for example (in particular in the case of touch-sensitive display screens being situated therebehind, for example in accordance with the “projected capacitive touchscreen” principle), the thickness in this case should be in the range of from 0.1 to 30 mm, preferably of from 0.2 to 20 mm, for example of from 0.2 to 10 or of from 2 to 18 mm, in particular due to the use of the “projected capacitive touchscreen” principle). The thickness may be, for example, 2 to 8 mm or 3 to 12 mm.

By way of example, cladding elements which are equipped or used according to the invention can have surface areas of from 2 to 500 square meters (m²), such as of from 3 to 50 m², without this intending to be restrictive.

According to the invention, a cladding element of this kind is mounted in front of or on the substrate of a surface in a building interior, in particular a wall, a ceiling or a floor of a building (building interior), or in front of or on the substrate of at least one surface on the outside of a building (for example outer wall or outside of a roof) or of two or more of these regions, substantially over the entire control-side substrate surface (in the installed state, the preferred embodiment of the invention), wherein said cladding element, if need be, can be divided into a plurality of cladding element modules, which are interconnected with as few joints as possible, preferably only with very smooth and narrow joints with a width of less than 2 mm (or in particular with a width of less than 1 mm) (“without a joint”), possibly closed by putty (preferably with the surfaces being flush and flat, that is to say so as to form a plane), for example if the individual cladding element modules can only be produced up to a maximum size but preferably is designed without an interruption in any piece. This means that said cladding element is in direct contact with the wall, ceiling, floor or roof substrate (wall, ceiling, floor or roof material), for example a (in particular ceiling, floor, roof or in particular wall) material selected from amongst concrete, masonry, for example of shaped stones, stones, cemented stones or shaped stones, stone (such as granite or marble) plates, clay bricks, bricks, wood, a composite material, or furthermore plastic, or the like, in each case with or without insulation and/or rendering material, (for example by application or at least partial cohesive connection, for example by adhesive bonding); or may be at a certain distance therefrom, for example at a distance of a few millimeters to centimeters, for example of from 1 to 50 mm or up to 500 mm, on that side which faces away from the observer and which faces the substrate, as a result of which it is possible, for example, to smooth unevenness of the substrate material or provide a, for example, insulating interspace or space for the energy supply module or modules. To this end, said cladding element can be kept at a suitable distance by spacers and can be connected, for example, in a separable manner (for example using screws) or (at least substantially, that is to say under normal usage conditions, in particular without irreversible damage during separation) in an inseparable manner (for example in a cohesively connected manner (such as adhesively bonded, soldered or welded) or in an interlocking manner (for example by means of undercuts).

“On the substrate side” means a position on that side (for example surface) of the cladding element which faces the respective (wall, floor, ceiling and/or roof) substrate.

“On the viewing side” means a position on that side (for example surface) of the cladding element which is averted from the respective planar building part (which is averted from the (wall, floor, ceiling and/or roof) substrate), that is to say that side which faces an imaginary observer standing in front.

A “planar building part” is intended to be understood to mean, in particular, a wall (on the inside or on the outside), a floor, a ceiling or a roof of a building, in particular in an OR, a room which is subject to moisture or an outer surface of a building which can come into contact with moisture (that is to say is accessible to moisture as explained above).

A transmission apparatus according to the invention for electrical energy and/or electrical signals allows the transmission of the electrical energy from the supply module for electrical energy to the discharge module, the transmission of electrical signals from the supply module to the discharge module or in the opposite direction with the aid of an (electro)magnetic alternating field (in accordance with the induction principle, that is to say inductively), or the transmission of electrical energy and electrical signals from the supply module to the discharge module or vice versa when these two types of module are at a sufficiently short distance from one another.

Advantageously and in order to comply with the limit values for disturbance radiation, the supply module(s) and discharge module(s) are designed for targeted energy transmission between the supply module and the discharge module without scatter into the surrounding area, wherein disturbance radiation which is possible during the inductive energy transmission is shielded by corresponding shaping of the elements (for example coils) which emit and receive (electro)magnetic fields for emission which is targeted as far as possible (to one another, in particular from the supply module to the discharge module); by suitable shielding of the supply and the discharge module(s), for example by means of the emitting and receiving elements on the outside at least to such an extent that, jointly in the event of use (positioning the supply module and the discharge module opposite one another on the cladding element), an effect such as that in a Faraday cage is achieved, shielding magnetizable metal components (such as iron (for example in the form of ferrite), nickel or cobalt) and/or electrically conductive metal components (such as, for example, foils, lattices, nets, plates, wire meshes, wires, metal housings); or both, at least to such an extent that limit values for disturbance radiation can be complied with.

“Electrical signals” are intended to be understood to mean, in particular, signals for transmitting information, for example for driving apparatuses and/or for data transmission, for example, between measurement apparatuses, computers, input apparatuses or the like for data-processing apparatuses. Examples of signals may be measurement signals, signals for the transmission of sound (and also for telephony or the like), control signals (for example for switching apparatuses on and switching apparatuses off), signals for data transmission or the like.

In this case, it is possible to transmit electrical energy and/or electrical signals from the supply module for electrical energy and/or electrical signals through the cladding element to the discharge module and/or to transmit electrical signals in the opposite direction without an interruption, that is to say without the cladding element which is fitted with these two modules on the opposite sides (as otherwise required, for example, in the case of normal plug receptacles or connection sockets) having an interruption (for example for directly establishing electrical contact between the supply module and the discharge module). Therefore, joints, for example, for otherwise customary plug receptacles or sockets can be avoided. The opposite surfaces of the cladding element can preferably be designed in a completely uncompromised manner in the region of the current discharge module (in particular completely in one plane with the surrounding surface of the cladding element), and therefore in a manner which is particularly easy to keep clean from the outside or from the room side, or can be designed to be resistant to moisture.

In this case, the supply module for electrical energy and/or electrical signals is, in the mounted state (which can be used for energy and/or signal transmission to the discharge module), arranged on the substrate side (for example in cutouts, or on the substrate surface) and preferably (in order to minimize energy losses during inductive transmission) is mounted in close contact (preferably flush) with the corresponding surface of the cladding element, for example (substantially in a force-fitting manner) by corresponding counter-pressure of the wall, ceiling, floor or roof substrate or in particular by adhesive bonding or (for example by means of adhesively bonded mating pieces) screwing by means of screw elements (nuts, bolts) or furthermore by clip-action/snap-action by means of snap-action mechanism elements or the like. The supply module for electrical energy and/or electrical signals is therefore generally stationary. In the figurative sense, said supply module is a “joint-free inductive plug receptacle” without an interruption, this not being intended to restrict the meaning of the term ‘supply module’ for electrical energy and/or electrical signals.

The supply module for electrical energy and/or electrical signals contains a converter electronics and electrical system for converting supplied (for example direct or alternating) current and/or electrical signals into a magnetic alternating field (which is directed as far as possible in the direction of the current discharge module which is situated opposite in the mounted state). This supply module is advantageously designed in such a way that the disturbance radiation is shielded, by corresponding shaping of the elements (for example coils) which emit and receive (electro)magnetic fields for emission which is targeted as far as possible; by suitable shielding, for example by means of the emitting and receiving elements, toward the outside at least to such an extent that, jointly in the event of use (positioning the supply module and the discharge module opposite one another on the cladding element), an effect such as that in a Faraday cage is achieved, shielding magnetizable metal components (such as iron (for example in the form of ferrite), nickel or cobalt) and/or electrically conductive metal components (such as, for example, foils, lattices, nets, plates, wire meshes, wires, metal housings); or both; apart from in the region which is intended to pass electromagnetic radiation, at least to such an extent that the limit values for disturbance radiation can be complied with, in particular in combination with the cladding element and the respectively opposite discharge module.

The current and/or the electrical signals are supplied to the supply module for electrical energy via customary connections (for example from the building's own power supply system and/or data-processing system, such as LAN or Ethernet).

In addition, the supply module for electrical energy and/or electrical signals can, in a specific embodiment, advantageously have, in (in a manner integrated in the module) or on (on its corresponding surface) the region which faces the cladding element, as a device for fastening the discharge module without an interruption and in a releasable manner, an arrangement (which is, for example annularly, closed or interrupted in the form of a polygon) of one or more passively magnetizable (that is to say paramagnetic, in particular ferromagnetic) elements which can allow the discharge module to be firmly held in interaction with magnetic fields which emanate from the discharge module, wherein, in this case too, solenoids (in this case, however, with more energy consumption since in this case energy is consumed even in the absence of a discharge element, it being possible to counteract this by control elements which notice the presence or absence of the discharge module (for example by means of RFIDs) and can prevent the supply of energy to said solenoids when the discharge module is absent) can be provided, it being possible for said solenoids to be driven by the supplied current and for corresponding magnetic interaction with (in particular passively magnetizable, that is to say paramagnetic, for example in particular ferromagnetic) elements in the discharge module for fastening said discharge module in a releasable manner. The supply module is particularly advantageously designed such that it can be switched off in each case (for example by switching off the supply of current by means of a switching element, such as a switch, or by elements which allow automatic switch-off when the discharge module is removed) in order to prevent unnecessary emission from the cladding element at the time at which there is no discharge module situated opposite it.

The discharge module contains a converter electronics and electrical system (for example with a reception coil) which converts applied magnetic alternating fields into a DC or AC voltage or, in the case of signals, into electrical signals (or both) which can create electric current (flow) or electrical signal transmission by means of suitable electrical circuits when said circuits are closed. In the case of reversed signal transmission from the discharge module to the supply module, the converter electronics and electrical system can also contain the devices which are required for this purpose. The discharge module can be connected to (brought into contact with) the cladding element in a releasable manner and therefore can be used in a non-stationary manner. In the figurative sense, said discharge module is a mobile “inductive plug”, this not being intended to restrict the meaning of the term “discharge module”. The discharge module is advantageously designed in such a way that the disturbance radiation is shielded, by corresponding shaping of the elements (for example coils) which emit and receive (electro)magnetic fields for emission which is targeted as far as possible; by suitable shielding, for example by means of the emitting and receiving elements, toward the outside at least to such an extent that, jointly in the event of use (positioning the supply module and the discharge module opposite one another on the cladding element), an effect such as that in a Faraday cage is achieved, shielding magnetizable metal components (such as iron (for example in the form of ferrite), nickel or cobalt) and/or electrically conductive metal components (such as, for example, foils, lattices, nets, plates, wire meshes, wires, metal housings); or both; apart from in the region which is intended to pass electromagnetic radiation, at least to such an extent that the limit values for disturbance radiation can be complied with, in particular in combination with the cladding element and the respectively opposite supply module.

A lock and release electronics system can advantageously be provided in the discharge module separately or in combination with the last-mentioned converter electronics and electrical system as a device for fastening the discharge module without an interruption and in a releasable manner, said lock and release electronics system allowing magnetic fields to be built up in an electromagnetic manner (for example by means of corresponding coils or differently shaped solenoids), it being possible for said magnetic fields to effect releasable fastening of the discharge module to the cladding element by interaction with the arrangement or the arrangements of one or more passively magnetizable (that is to say paramagnetic, in particular ferromagnetic) elements and/or of solenoids in the supply module which is situated opposite said discharge module behind the cladding element in the mounted state. The attraction between the supply module and the discharge module can be activated and, respectively, terminated by switching on and switching off said magnets using the lock and release electronics system, for example by means of a suitable (for example touch-sensitive, optical, acoustic or mechanical) switch (for example pushbutton) which is provided on/in the discharge module, so that said discharge module can be reversibly fastened.

The discharge module can be connected to current conductors by means of customary releasable contacts or by means of permanent contacts. Therefore, in the case of releasable connection, said discharge module can be equipped with a socket (for example a plug receptacle), a panel plug, spring contacts, releasable screw connections (for example luster terminals), terminals or cable shoes to which corresponding current conductors (for example integrated in devices or apparatuses which are to be supplied with current and/or which are to be influenced by one or more currents (for example which are to be controlled by signals) so that said devices or apparatuses can be directly connected, or connected by means of current conductors such as cables) can be connected, for example by means of plugs, couplings or other customary suitable mating pieces (including free wire ends) for example of the last-mentioned releasable contacts. Examples of suitable pairings/systems are those for single-phase domestic plug systems such as, for example, the American 2-pin plug system (type A), the American 3-pin plug system (type B), European flat plug (type C, CEE 7/16), the Indian/old British plug system (type D), the French plug system (type E), the German/French combination plug (type EF, CEE 7/7), the European contour plug (type EF, CEE 7/17), the German shockproof plug system (type F, CEE 7/4), the Russian plug system (type F, GOST 7396), the British plug system (type G, BS 1363), the Israeli plug system (type H), the Australian plug system (type I), the Swiss plug system (type J), Danish plug system (type K), Italian plug system (type L), the South African plug system (type M), IEC 60906-1 the international standard plug, the Brazilian plug NBR 14136, or the like, but also PowerCon, plugs which are compliant with DIN 56905, Terko plugs, low-voltage plugs, such as hollow plugs, Molex plugs, plug connectors for PC power supply units, wire spring contacts, banana plugs, patch panels, BNC plug connectors, cinches for the transmission of signals (for example audio, video), diode plugs, phone jacks, XLR, BNC, SCART, mini DIN (S-video), Belling-Lee plugs, VGA connections, Ethernet plugs, TEAR plug systems, ELine 1200 EC7, N plugs, USB plugs, FireWire plugs, SATA plug connectors, SAS plug connectors, PS/2 plugs, telephone connections, such as TAE, ISDN plugs, universal plugs or universal adapters, or similar systems. One or more plug receptacles, for example for the above-mentioned domestic plug systems, which are used, in particular, in operating rooms (ORs) are particularly preferred, primarily for supplying devices and apparatuses in the OR with mains voltage, or in rooms which are subject to moisture or on walls which can come into contact with moisture.

The permanent connection (which necessarily includes releasable connection in this case) can be established in a customary manner, for example by means of soldered arrangements, wire winding techniques, insulation-displacement terminals, press-in contacts, welded arrangements, bonding connections, adhesive-bonding connections with conductive adhesives, pressure connections, crimp connections, rivet arrangements or splice connections.

In this case, “fastened in a releasable manner” means that the discharge module is held on the cladding element in the region opposite the supply module. In addition to the magnetic forces cited in the preceding text and that which follows, this can also be performed by negative pressure (for example suitable suction cups), wherein the negative pressure can also be produced by a corresponding pumping apparatus which is accommodated in the discharge module and which can be driven, for example, by induction current using some of the electrical energy and/or electrical signals which is/are supplied by the supply module. Adhesion due to nanoscale surface-treatment of the surface of the current discharge module which faces the cladding element can also be used to fasten the current discharge module in a releasable manner (“gecko effect”).

“Level with” means, in particular, that the supply module and discharge module are arranged physically in relation to one another in the use state in such a way that the inductive transmission of energy between them can take place to a sufficient extent and largely or entirely without emission of disturbance radiation to surrounding regions (that is to say the corresponding coils or the like substantially physically coincide or one (in particular that in the discharge element) is larger than the other and therefore is superimposed on the edge of the latter so as to extend beyond it) and (possibly magnetic) fastening mechanisms which act one on the other (for example magnetic fields) can be effective between them, for example by said fastening mechanisms coming to lie such that one covers the other. By way of example, the two modules which are arranged on the opposite sides of the respective cladding element can be arranged in such a way that their entire surfaces which face the cladding element cover substantially, that is to say, for example, 80, 90, 95, 98 or preferably 100%, as viewed perpendicularly to the cladding element.

The supply and the discharge module(s) are advantageously shielded toward the outside by shielding elements comprising magnetizable metal (such as iron (for example in the form of ferrite), nickel or cobalt) and/or electrically conductive metal, such as foils, lattices, nets, plates, wire meshes, wires, metal housings for example, overall in such a way that they do not emit any disturbance radiation or only permissible quantities of disturbance radiation in regions other than those between transmission and reception elements (for example coils); this allows conformity with the directives and limit values cited in the introductory part. The shielding elements of the respective supply module advantageously form, in combination with the cladding element and the respectively opposite discharge module, a kind of Faraday cage.

In this case, “inductive transmission of electrical energy” is intended to be understood to mean the transmission of energy which is based on electrical energy through non-conductors which occurs by means of magnetic alternating fields (can also be represented as electromagnetic alternating fields using Maxwell's equations) and under inductive coupling, that is to say in a contact-free manner (contact-free energy transmission). In other words, energy is transmitted between two electrical circuits by varying the magnetic flux Φ. This is generally performed by means of one or more coils (conductor loops with several turns) which are physically associated with one another in the supply module and in the discharge module in such a way that a sufficient portion of the energy which is emitted from the energy supply module side, preferably as large a portion as possible, can be converted into current by the discharge module. The energy received by the discharge module in its reception coil(s) preferably reaches 50, 60, 70, 75, 80, 85, 90, 91, 92, 93, 94, 95 or more of the energy which is fed to the transmission coil(s).

By way of example, the converter electronics and electrical systems of the supply module and of the discharge module can advantageously be matched in such a way that they operate in accordance with the resonance principle, in order to ensure a particularly high inductive energy transmission rate.

As an alternative or in addition to energy, signals containing information (data) can also be transmitted to the supply module by means of the discharge module, and/or vice versa. In other words, the discharge module can, in this case, likewise act as a (signal-emitting) transmission module of energy for signals, the supply module can act as a (receiving) “current discharge module” of energy for those signals which are transmitted between said transmission module and supply module by magnetic alternating fields. Therefore, information can be transmitted from electronic devices or computers and back, for example. Therefore, data, and not only electrical energy, can also be transmitted in an inductive manner. In addition to the use of the induction principle, data can also be transmitted in an optical manner, for example by means of IR or light signals, wherein the converter electronics and electrical systems of the supply module and discharging modules then contain corresponding converters.

In a further embodiment, the invention also relates, in particular, to an outer wall of a building, or in particular a room in a building, in particular a room which is subject to moisture or an operating room which has at least one structure selected from amongst a wall, a ceiling and a floor and to which one or more planar cladding elements according to the invention are fitted, at least one supply module for electrical energy and/or electrical signals as described in the preceding text and that which follows being provided on the substrate side of said cladding element, wherein in each case one cladding element or other joint-free materials can likewise cover the remaining walls (with preference in the case of an operating room), the ceilings and optionally also the floor.

A “room which is subject to moisture” includes rooms in which water is used, for example a bathroom, the kitchen or a lavatory, for example in a residential building. Public swimming baths, (communal) showers and saunas are likewise rooms which are subject to moisture. A “wet room” is a room which is subject to moisture and in which so much water is produced that a floor drain is required. “Rooms which are subject to moisture” are intended to be understood to mean, in particular, rooms which are subject to a slight or in particular moderate level of moisture (use class) A01, A02, subject to, for example, the action of splashing)), or in particular rooms which are subject to a high level of moisture (use class A1 pursuant to Bauregelliste [German building codes of practice list] A, part 2 (wall surfaces which are exposed to large amounts of service and cleaning water), A2 (floor surfaces which are exposed to large amounts of service and cleaning water), B (pursuant to Bauregelliste A, part 2, wall and floor surfaces in indoor and outdoor swimming pools (with internally pressurized water)) or C (pursuant to Bauregelliste A, part 2, wall and floor surfaces which are exposed to large amounts of water in conjunction with chemicals), such as corresponding garages, washrooms, indoor swimming pools, steam baths or other baths, saunas, bathrooms, kitchens, lavatories, shower rooms, swimming pools, cold stores, laboratories or the like.

In this case, “fitted” means that the cladding element or the cladding elements are fitted in front of or on the wall substrate of one or more walls (preferably), of the floor or of the ceiling, or of a roof, for example all walls, or all interior surfaces (walls, floor and ceiling) of a building interior or one or more outer walls substantially over the entire surface area thereof. This means that the covering element or the covering elements can be in direct contact with the substrate (wall, ceiling, floor and/or roof material), for example a material selected from amongst concrete, masonry, for example from shaped stones, stones, cemented stones or shaped stones, stone (such as granite or marble) plates, bricks, clay bricks, wood, a composite material, or furthermore plastic, or the like, in each case with or without insulation and/or rendering material (for example by application or at least partial adhesive bonding); or may be at a certain distance therefrom, for example as described above.

A “building” is intended to be understood to mean, for example, a residential building with one or more apartments (apartment building), an industrial building (preferably, in particular in the case of rooms which have special hygiene requirements, such as in biotechnology or microsystem technology), for example a laboratory building, an office building or, in particular, a hospital building or another kind of building (for example for outpatient operations), including correspondingly equipped containers, with rooms for performing surgery, but also a building with another function, such as a garage, an underground garage, an indoor swimming pool or the like.

When a supply module and a discharge module are used according to the invention, the energy and/or the electrical signals are transmitted inductively in the installed state, as described above. The transmitted electrical energy can then be forwarded from the discharge module as electric current to a current consumer in a further use step, and in both directions from and to suitable signal-processing apparatuses in the case of electrical signals.

In a method according to the invention for transmitting electrical energy and/or electrical signals through a cladding element for surfaces of planar building parts, in which method current and/or electrical signals is/are converted into a magnetic alternating field (often also called an electromagnetic alternating field in this document) in a supply module for electrical energy and/or electrical signals which is arranged behind (on the substrate side of) said cladding element without interruption, (at least the majority of) said alternating field being received by a discharge module which is arranged on that side of said cladding element (from the viewing side) which is opposite the supply module without an interruption and in a releasable manner and being converted into a voltage, the terms likewise have the meanings cited in the preceding text and possibly that which follows. In the discharge module, the voltage can create a voltage which can create a current in a further method step (for example closing of an electrical circuit), which current can be or is fed to a current consumer and/or a signal-emitting and/or signal-processing apparatus.

“Without an interruption” also means, in particular, that there are no grooves or joints (or at least no joints with a width of more than 2 mm or with a width of more than 1 mm) in the cladding element or on the surface of said cladding element at the location of the supply and the discharge modules.

### BRIEF DESCRIPTION OF THE DRAWINGS

The figures show specific embodiments of the invention, without restricting the scope thereof. The following description of the figures is part of the disclosure of the invention:

FIG. 1 (FIG. 1) schematically shows, in cross section, a transmission apparatus according to the invention for electrical energy and/or electrical signals in the installed state in which it can be used for transmitting current and signals, which transmission apparatus has a supply module for electrical energy and/or electrical signals and a discharge module arranged on opposite sides, it being possible for said supply module and discharge module to be connected to one another in a releasable manner in such a way that the electrical energy can be transmitted.

FIG. 2 schematically shows, in cross section, a transmission apparatus according to the invention for electrical energy and/or electrical signals in a state in which the supply module for electrical energy and/or electrical signals still remains behind the cladding element on or in the substrate of the planar building part, while the discharge module is shown in the separated (released) state.

FIG. 3 shows, at the top, a transmission apparatus according to the invention for electrical energy and/or electrical signals in a highly schematic side view in cross section (parallel to the surface of the cladding element), and, at the bottom, said transmission apparatus in a viewing direction perpendicular to the surface of the cladding element.

### DETAILED DESCRIPTION OF THE PREFERRED EMBODIMENTS

The following example serves to illustrate the invention without restricting the scope thereof. This example is also a specific embodiment of the invention.

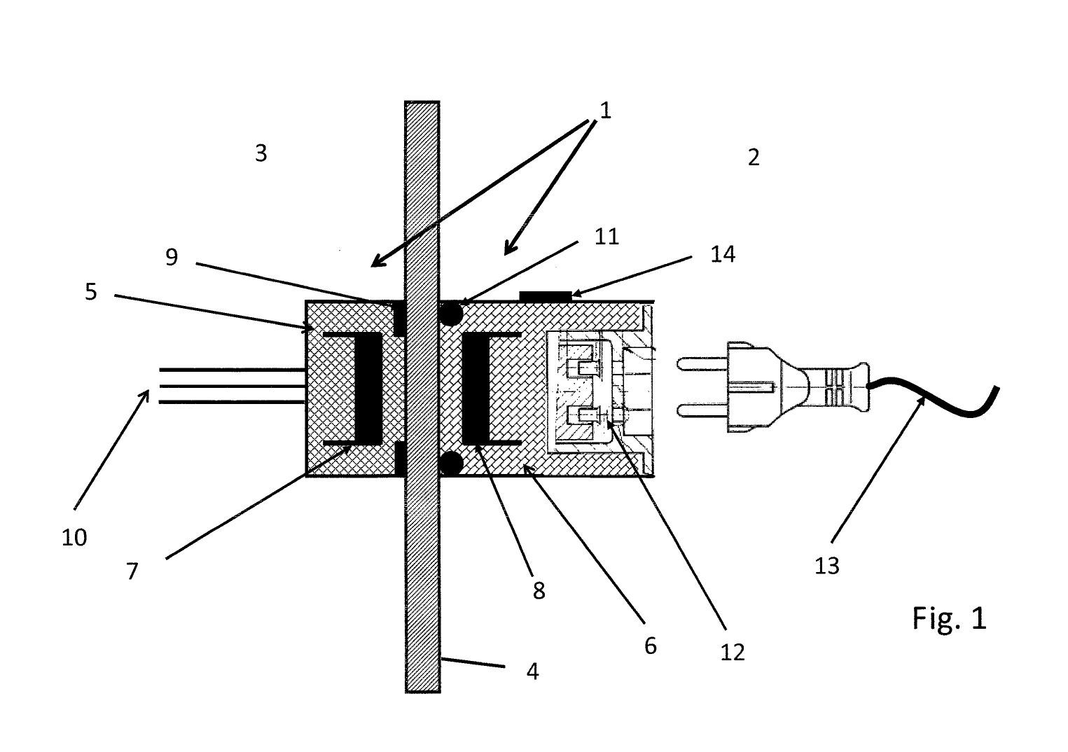

FIG. 1 shows, by way of example, a transmission apparatus 1 according to the invention for electrical energy and/or electrical signals, which transmission apparatus has a discharge module 6 for electric current and/or electrical signals on the viewing side 2 of a sheet-like cladding element 4, for example an acrylic glass or glass pane, while it has a supply module 5 for electrical energy and/or electrical signals on the substrate side 3 (for example wall side) of the sheet-like cladding element 4. The supply module 5 can be recessed, for example, into the wall or can be mounted onto said wall or can be partially recessed. The supply module 5 has, in its interior, a converter electronics and electrical system 7 which can be supplied with current and electrical energy by an electrical connection 10, in this case, for example, to the power supply system of a building, wherein further connections (not illustrated), for example to data transmission lines, can also be provided. A material 9, which is passive and magnetizable in this case (for example ferromagnetic iron or another ferromagnetic material, instead of which a solenoid can also be provided) and which can be arranged, for example, in an annular manner (with or without an interruption) parallel to the surface of the sheet-like cladding element 4, allows magnetic interaction with at least one solenoid 11 in the discharge module 6 (in this case, a passive magnetizable material which interacts with a solenoid instead of 9 can be provided instead of said solenoid 11), wherein the resulting force holds the supply module 5 in its position such that it is fastened in a releasable manner. The at least one solenoid 11 can be supplied with current by the inductive transmitted energy from the supply module, and therefore build up a magnetic field. In addition to 11, the discharge module 6 contains a converter electronics and electrical system 8 (which can be referred to as secondary). This converter electronics and electrical system can firstly convert a magnetic alternating field (for example using at least one suitable coil) into a voltage which allows a current or electrical signals to be tapped off, in this case, for example, by means of a contact point for current discharge 12, shown in this case, by way of example, in the form of a plug receptacle, via a current conductor 13, shown in this case equipped with a plug by way of example, which plug can be brought into contact with the contact point for current discharge 12, and secondly can supply current (which is obtained from the inductive transmission or else, for example, stored in a rechargeable battery which is not shown) to the at least one solenoid 11.

The electrical energy is converted into said electromagnetic alternating field in the supply module 5 in the converter electronics and electrical system 7 (can be called primary) of said supply module (for example by means of at least one coil), said converter electronics and electrical system advantageously being designed in such a way that it allows the inductive electromagnetic field to be emitted in a targeted manner in the direction of an opposite discharge module 6, said electromagnetic alternating field allowing the energy and/or the electrical signals to be inductively transmitted to the discharge module 6, where said electromagnetic alternating field can then be converted into a voltage (for supplying the at least one solenoid 11 and/or the contact point for the current discharge 12) which can be tapped off by induction by means of the converter electronics and electrical system of said discharge module.

For shielding purposes, at least one shielding element is advantageously provided, said shielding element surrounding the element or elements (for example a coil), which emits/emit the electromagnetic alternating field, toward the outside at least to such an extent that, jointly in the event of use (positioning the supply module and the discharge module opposite one another on the cladding element), an effect such as that in a Faraday cage is achieved, for example by means of shielding magnetizable metal components (such as iron (for example in the form of ferrite), nickel or cobalt) and/or electrically conductive metal components (such as, for example, foils, lattices, nets, plates, wire meshes, wires, metal housings) (not shown).

In other words, the discharge module 6 in this case allows electrical energy to be supplied from the supply module 5 to the contact point for the current discharge 12 in a contact-free manner, so that altogether, a plug receptacle can be produced, as shown by way of example, without the covering element being interrupted.

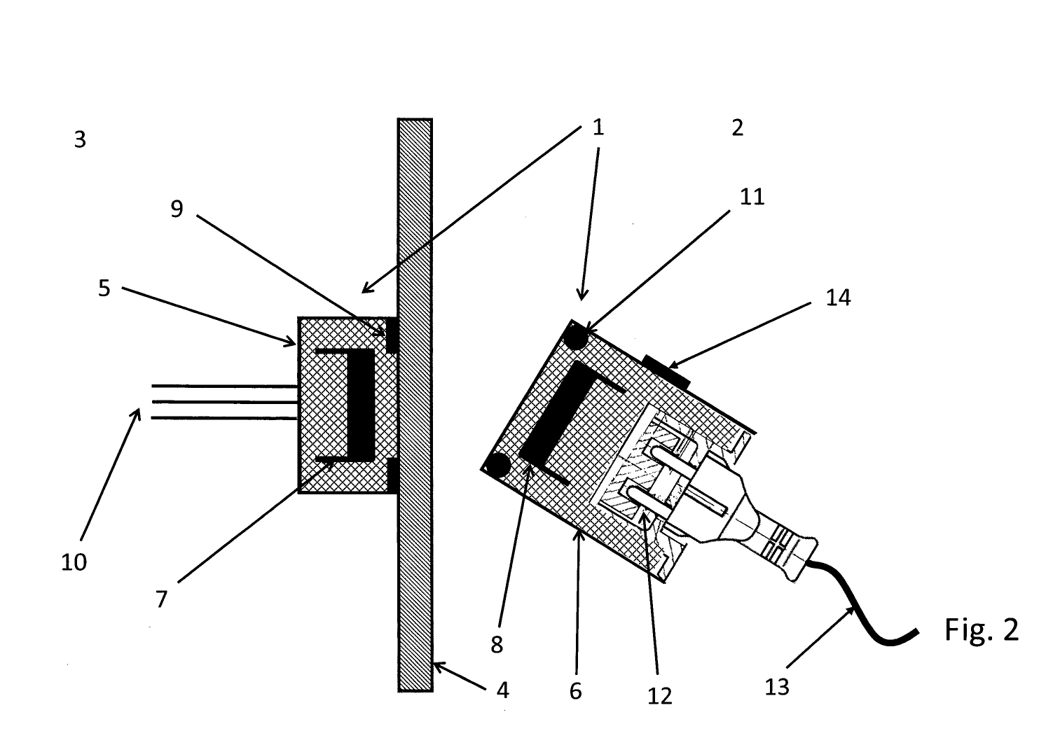

Due to its ability to be released, the discharge module 6 can be removed, for example by pressing a locking button 13, as a result of which the supply of current to the solenoid 11 can be interrupted, so that the magnetic field which holds the discharge module 6 in position opposite the supply module is switched off and the discharge module 6 is consequently no longer held and can be removed. The discharge module 6 and the surface of the cladding element 4 on which said discharge module was situated in the operating position can then, for example, be kept clean without problems (no permanent joints). The corresponding situation after removal of the discharge module 6 is shown, by way of example, in FIG. 2.

At least one shielding element is advantageously also provided for shielding purposes in the discharge module or the discharge modules 6, said shielding element surrounding the element or the elements (for example a coil), which emits/emit the electromagnetic alternating field, toward the outside at least to such an extent that, jointly in the event of use (positioning the supply module and the discharge module opposite one another on the cladding element), an effect such as that in a Faraday cage is achieved, for example by means of shielding magnetizable metal components (such as iron (for example in the form of ferrite), nickel or cobalt) and/or electrically conductive metal components (such as, for example, foils, lattices, nets, plates, wire meshes, wires, metal housings) (not shown).

By way of example, the contact point for current discharge 12 and the contact point on the current conductor 13 can be country- or region-specific standard plug receptacles and plugs. As an alternative, the contact point on the current conductor 13 can be connected directly to the conductors for the current discharge 12 (virtually permanent or releasable only, for example, by screwing), so that the entire discharge module 6 constitutes a kind of “plug”-like connection.

Data transmission is also possible by means of corresponding modulation of the magnetic alternating field in the region between 5 and 6, in addition to the transmission of energy or as an alternative to it. This can be performed, for example, by means of apparatuses, which are accommodated in the wall material, for transmitting WLAN signals or Ethernet or the like which perform inductive transmission from the energy supply module 5 to the current discharge module 6 and there, after corresponding conversion into signals, for example for transmission of data or control instructions, said signals can be forwarded to connected computers or software-controlled devices or apparatuses, and/or in the opposite direction.

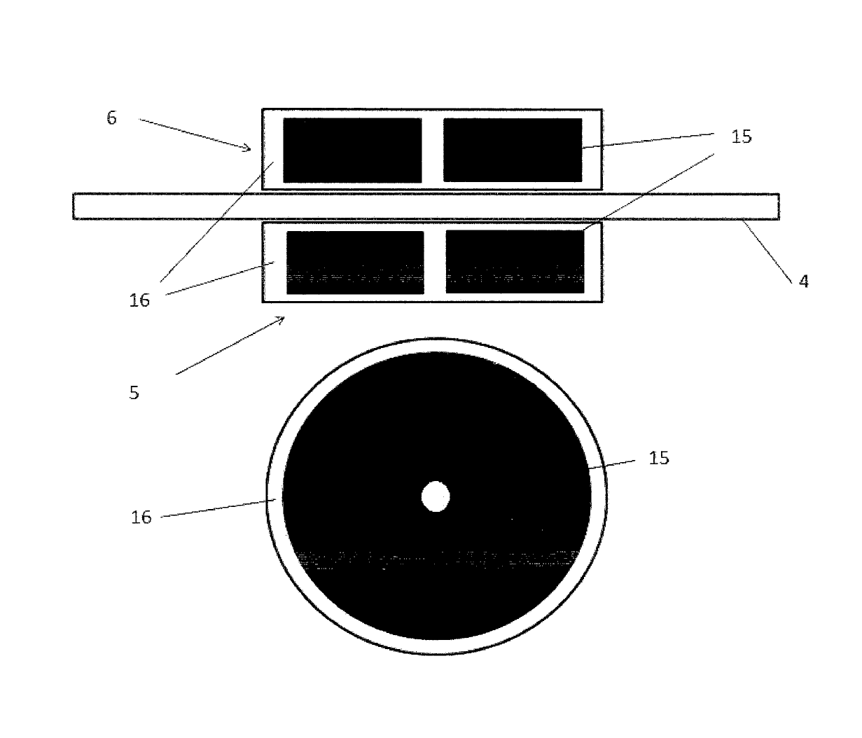

FIG. 3 shows, in a highly schematic manner, a combination comprising a supply module 5, a discharge module 6 and a cladding element 4 according to the invention, wherein the coil windings 15 of the supply module 5 and of the discharge module 6 are designed in such a way that they completely overlap and are each surrounded by a casing 16, for example composed of ferrite or a metal. Together, this arrangement ensures particularly good shielding and therefore a high level of efficiency in respect of energy transmission and only a very low level of emission of disturbance radiation.

1. A sheet-like cladding element (4) for surfaces of planar building parts, said cladding element is equipped with a transmission apparatus (1) for electrical energy and/or electrical signals, said transmission apparatus comprises a supply module (5) for electrical energy and/or electrical signals and a discharge module (6) for electric current and/or electrical signals, it being possible for said supply module and discharge module to be releasably connected to one another in such a way that the electrical energy and/or the electrical signals can be transmitted, characterized in that, in the transmission apparatus (4) which is mentioned in the introductory part, the supply module (5) is arranged behind the cladding element (4) without an interruption, while the discharge module (6) is arranged in front of the cladding element (4) without an interruption, and the two modules (5, 6) contain elements for inductive transmission of electrical energy from the supply module (5) to the discharge module (6) and/or of electrical signals from the supply module (5) to the discharge module (6), in an opposite direction or in both directions, and also contain devices for fastening the discharge module (6) without an interruption and in a releasable manner.

2. The cladding element as claimed in claim 1, characterized in that disturbance radiation is shielded, by appropriate shaping of elements which emit and receive electromagnetic alternating fields which are used for the transmission of electrical energy by means of inductive transmission; by suitable shielding; or both, at least to such an extent that limit values for disturbance radiation can be complied with.

3. The cladding element (4) as claimed in claim 1 or 2, which is opaque or at least partially transparent in a range which is visible to the human eye and is composed of an electrically non-conducting and non-magnetizable material selected from amongst ceramic, acrylic glass and all glass.

4. The cladding element as claimed in one of claims 1 to 3, characterized in that its thickness is in the range of from 0.1 to 100 mm, preferably in a range which allows transmission of the electrical energy in accordance with the induction principle with as low a level of loss as possible, in particular in the range of from 0.1 to 20 mm, for example in the case of touch-sensitive display screens situated behind said cladding element, for example in accordance with the “projected capacitive touchscreen” principle, in the range of from 0.1 to 30 mm, preferably of from 0.2 to 20, for example of from 0.2 to 10 or 2 to 18 mm, such as 2 to 8 mm.

5. The cladding element as claimed in one of claims 1 to 4, characterized in that it has a surface area of from 2 to 500 m², preferably of from 3 to 50 m².

6. The cladding element (4) as claimed in one of claims 1 to 5, characterized in that it is mounted in front of or on the substrate of at least one surface in a building interior in the form of a wall, a ceiling or a floor of an interior of a building selected from amongst a room which is subject to moisture and an operating room, or in front of or on the substrate of a building outer surface which is accessible to moisture, substantially over the entire substrate surface.

7. The cladding element (4) as claimed in one of claims 1 to 6, characterized in that it is designed in such a way that the transmission of the electrical energy and/or of the electrical signals from the supply module (5) for electrical energy and/or electrical signals to the discharge module (6) and/or, in the case of electrical signals, in the opposite direction can be performed with the aid of an electromagnetic alternating field.

8. The cladding element (4) as claimed in one of claims 1 to 7, characterized in that, in the mounted state, the supply module (5) is arranged on the substrate in close contact with the corresponding surface of the cladding element, and contains a converter electronics and electrical system (7) for converting supplied (for example direct or alternating) current and/or electrical signals into a magnetic alternating field, and has an arrangement of one or more passively magnetizable elements, which can allow the discharge module (6) to be firmly held in interaction with magnetic fields which emanate from the discharge module (6), in or on a region which faces the cladding element as a device for fastening the discharge module (6) without an interruption and in a releasable manner, wherein, as an alternative, solenoids which can be driven by the supplied current and for corresponding magnetic interaction with (in particular passively magnetizable, that is to say paramagnetic, for example in particular ferromagnetic) elements in the discharge module (6), in each case for the purpose of fastening said discharge module in a releasable manner, can be provided there, and the discharge module (6) contains a converter electronics and electrical system (8) which converts applied magnetic alternating fields into a DC or AC voltage and/or into electrical signals which can produce an electric current (flow) by means of suitable electrical circuits when said electrical circuits are closed, and/or converts the conversion of electrical signals into magnetic alternating fields which allow transmission to the supply module (5), wherein a lock and release electronics system can be provided separately or in combination with the last-mentioned converter electronics and electrical system (8) as a device for fastening the discharge module without an interruption and in a releasable manner, said lock and release electronics system allowing magnetic fields to be built up in an electromagnetic manner (for example by means of corresponding coils or differently shaped solenoids), it being possible for said magnetic fields to effect releasable fastening of the discharge module (6) to the cladding element (4) by interaction with the arrangement or the arrangements of one or more passively magnetizable elements and/or of solenoids in the supply module (5) which is situated opposite said discharge module behind the cladding element in the mounted state, wherein a switch can be provided on the discharge module (6), it being possible for the attraction between the supply module (5) and the discharge module (6) to be activated and, respectively, terminated by said switch, so that said discharge module can be reversibly fastened.

9. The cladding element (4) as claimed in one of claims 1 to 8, characterized in that the discharge module (6) is connected to one or more current conductors (13) by means of customary releasable contacts or by means of permanent contacts.

10. The cladding element as claimed in one of claims 1 to 9, characterized in that the converter electronics and electrical systems of the supply module (5) and of the discharge module (6) are matched in such a way that they operate in accordance with the resonance principle.

11. A surface of a building part which is equipped with at least one cladding element (4) as claimed in one of claims 1 to 10, in particular a wall, floor, ceiling or roof surface which is accessible to moisture, or floor, ceiling or primarily wall of a building interior which is selected from amongst an operating room and a room which is subject to moisture.

12. The surface or building interior as claimed in claim 11, which is a room which is subject to moisture or an operating room.

13. The building interior as claimed in either of claims 11 and 12, in which one or more transparent planar cladding element or elements (4) according to the invention is/are fitted to at least one wall, the ceiling or the floor, at least one supply module (5) as described in one of claims 1 to 10 being provided on the substrate of said cladding element, wherein the remaining walls (with preference in the case of an operating room), the ceilings and optionally also the floor can each be covered by a covering element or other joint-free materials.

14. The building interior as claimed in one of claims 11 to 13, characterized in that each of its walls and optionally also the ceiling are each covered by a cladding element (4) as claimed in one of claims 1 to 9, said cladding elements being connected to one another in their edge regions with few joints.

15. The use of a supply module (5) for electrical energy and/or electrical signals, said supply module is arranged behind a sheet-like cladding element (4) for a surface of a planar building part as claimed in one of claims 1 to 10 in a building interior or on a building outer surface without an interruption, and the use of a discharge module (6) for electric current and/or electrical signals which is arranged on that side of the cladding element (4) which is opposite the supply module (5) without an interruption and in a releasable manner, for the inductive transmission of electrical energy and/or electrical signals from the supply module (5) to the discharge module (6) and/or, primarily in the case of electrical signals, in the opposite direction.

16. A method for the transmission of electrical energy and/or electrical signals through a sheet-like cladding element (4) for a surface of a planar building part as claimed in one of claims 1 to 10, characterized in that the current and/or the electrical signals is/are converted into a magnetic alternating field in a supply module (5) for electrical energy and/or electrical signals, which supply module is arranged behind said cladding element (4) without an interruption, said magnetic alternating field being at least partially received by a discharge module (6) for electric current and/or electrical signals, said discharge module is arranged on that side of said cladding element (4) which is opposite the supply module (5) without an interruption and in a releasable manner, and is converted into a voltage or into electrical signals, wherein conversely electrical signals can be converted into a magnetic alternating field by said discharge module (6) and transmitted to the supply module and received and converted into electrical signals there.
